(19) United States
(12) Patent Application Publication
(10) Pub. No.: US 2006/0262102 A1
(43) Pub. Date: Nov. 23, 2006

(54) Apparatus and method for displaying input window

(75) Inventor: Beom-seok Lee, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/429,965

(22) Filed: May 9, 2006

(30) Foreign Application Priority Data
May 17, 2005 (KR) 2005-41177

(51) Int. Cl. G09G 5/00

(52) U.S. Cl. 345/173

(57) ABSTRACT

An apparatus and method for displaying an input window on a screen are provided that allow an input field, the subject and additional information of the input field not to be overlaid or hidden by the input window that receives handwriting by a user. The apparatus comprises a cursor position determining unit to determine the position of a cursor; an input field searching unit to search for information on an input field when the cursor is present within the input field; an input window positioning unit to determine the position of the input window in such a manner that the input field or a static text field close to the input field is not overlaid or hidden, referring to information on the searched input field, the margin of the screen and the size of the input window; and a display unit to provide a visual display of the input window at the determined position.

### CROSS-REFERENCE TO RELATED APPLICATION

This application claims all benefits accruing under 35 U.S.C §119 from Korean Patent Application No.-2005-41177 filed on May 17, 2005, in the Korean Intellectual Property Office, the disclosure of which is incorporated by reference herein.

### BACKGROUND OF THE INVENTION

1. Field of the Invention

The present invention relates to a visual display of an input window on a screen, and more particularly, relates to an apparatus and a method for displaying an input window, in which the position of the input window to receive handwriting by a user is automatically adjusted so that an input field, a subject and additional information of the input field are not hidden.

2. Related Art

Many mobile devices, such as hand-held computers, personal digital assistants (PDAs) and tablet personal computers (PCs), utilize a stylus pen as a main input means to input or retrieve information. This is because these mobile devices structurally have no keyboard. A user of the PDA or the tablet PC clicks a button on a screen or inputs characters and/or figures on an electronically sensitive pad provided therein using a stylus pen. A screen can be a user interface (i.e., program interface) that allows a user to take advantage of such a mobile device's graphics capabilities to make a program easier to use. Such a user interface is developed to enable a user to input data without using a keyboard and to memorize a considerable number of complex commands.

To receive the input characters and/or figures, the mobile device typically allocates a predetermined space on the screen, which is referred to as an “input window.” Generally, when a button mounted on the mobile device, or an image button indicated on an electronically sensitive pad is clicked (activated), the input window appears on the screen. When the input of the characters or figures is completed, the input window disappears from the screen.

A region to display characters and/or figures input by a user on the screen is called an “input field”. The content handwritten by the user on the input window is recognized by a separate processing unit and then indicated on the input field.

After one or more input fields are displayed on the screen, a user who desires to input characters and/or figures into each input field, clicks a button mounted on the mobile device, or an image button displayed on the electronically sensitive pad, in order to display an input window on the screen. At this time, the input window may overlap and hide a displayed input field.

Practically, the content handwritten on the input window, via the stylus pen, is indicated in the input field after the handwriting of the content has been completed on the input window, that is, after the input window has disappeared. As a result, coverage of the input field would not create any problem, since the input window would overlap the input field. However, when the subject of the input field is hidden, this is likely to inconvenience the user. In other words, if multiple input fields are displayed on the screen, the user inputs the content into each input field through the input window. If the subject of the input field is hidden, however, the user has to move the displayed input window in order to determine the subject of the target input field.

FIGS. 1A to 1C show an example coverage by an input window of an input field on a screen in a typical mobile device, such as a hand-held computer. As shown in FIG. 1A, one or more input fields are listed on a screen 10. A user, who intends to input content into each input field, displays an input window 100 using a button mounted on the mobile device, or an image button displayed on an electronically sensitive pad, and inputs the content thereon. Afterwards, the user clicks the button or the image button so that the content handwritten on the input window 100 is read by a predetermined processing unit, converted into text and displayed on the target input field 50, and then the input window 100 disappears.

To input content into a different input field, the user positions a cursor on the input field in order to display the input window 100. At this time, the displayed input window 100 may hide the input field 50 and the subject of the input field 50 as shown in FIG. 1B. In this case, the user must move the input window 100 in order to determine the subject of the input field 50 as shown in FIG. 1C. As a result, it is necessary to display an input window 100 so that an input field 50 cannot be hidden or overlaid by the input window 100.

Korean Unexamined Patent Publication No. 2002-85309 discloses that, when a display mode (e.g., horizontal display, and vertical display) is changed in a mobile device having a touch screen, the size of the changed screen is analyzed and an empty space in the changed screen is calculated such that another input window for handwriting can be added in an empty space on a screen. As an additional input window is displayed on an empty space of the screen generated according to the display mode, the utilization of the screen space is increased. However, there is no disclosure of any method of displaying an input window in the state that an input field is not hidden or overlaid by the input window.

### SUMMARY OF THE INVENTION

Several aspects and example embodiments of the present invention provide to allow an input field, the subject and additional information of the input field not to be hid by an input window that receives handwriting by a user.

Additional aspects and/or advantages of the invention will be set forth in part in the description which follows and, in part, will be obvious from the description, or may be learned by practice of the invention.

In accordance with an embodiment of the present invention, an apparatus for displaying an input window to receive handwriting by a user, to be input into one or more input fields, comprises: a cursor position determining unit to determine the position of a cursor; an input field searching unit to search for information on an input field when the cursor is present within the input field; an input window positioning unit to determine the position of the input window in such a manner that the input field or a static text field close to the input field is not hidden, referring to information on the searched input field, the margin of the screen and the size of the input window; and a display unit to display the input window on the determined position.

In accordance with another embodiment of the present invention, a method for displaying an input window to receive handwriting by a user, to be input into one or more input fields, comprises: (a) determining the position of a cursor; (b) searching for information on an input field when the determined cursor is present within the input field; (c) determining the position of the input window in such a manner that the input field or a static text field close to the input field is not hidden, referring to information on the searched input field, the margin of the screen and the size of the input window; and (d) displaying the input window on the determined position.

In addition to the example embodiments and aspects as described above, further aspects and embodiments of the present invention will be apparent by reference to the drawings and by study of the following descriptions.

### BRIEF DESCRIPTION OF THE DRAWINGS

A better understanding of the present invention will become apparent from the following detailed description of example embodiments and the claims when read in connection with the accompanying drawings, all forming a part of the disclosure of this invention. While the following written and illustrated disclosure focuses on disclosing example embodiments of the invention, it should be clearly understood that the same is by way of illustration and example only and that the invention is not limited thereto. The spirit and scope of the present invention are limited only by the terms of the appended claims. The following represents brief descriptions of the drawings, wherein:

FIGS. 1A to 1C illustrate how an input window overlaps an input field on a screen in a conventional mobile device;

FIG. 2 illustrates an apparatus for displaying an input window according to an embodiment of the present invention;

FIG. 3 is a block diagram of an apparatus for displaying an input window according to an embodiment of the present invention;

FIG. 4 illustrates a basic position of an input window depending upon the position of an input field according to an embodiment of the present invention;

FIGS. 5A and 5B illustrate an example rearrangement of an input window when the input window is partially or wholly departed from the screen according to an embodiment of the present invention;

FIG. 6 illustrates a visual display of an entire input window by scrolling the screen when the input window is partially or wholly departed from the screen according to an embodiment of the present invention;

FIG. 7 illustrates a visual display of an example subject in a target input field in a partial region of the input window according to an embodiment of the present invention;

FIG. 8 illustrates a visual display of an input window on the position of an input field according to an embodiment of the present invention;

FIG. 9 is a flow chart illustrating a visual display of an input window in such a manner that an input field is not hidden or overlaid according to an embodiment of the present invention; and

FIG. 10 illustrates a visual display of an input window in such a manner that an input field is not hidden or overlaid according to an embodiment of the present invention.

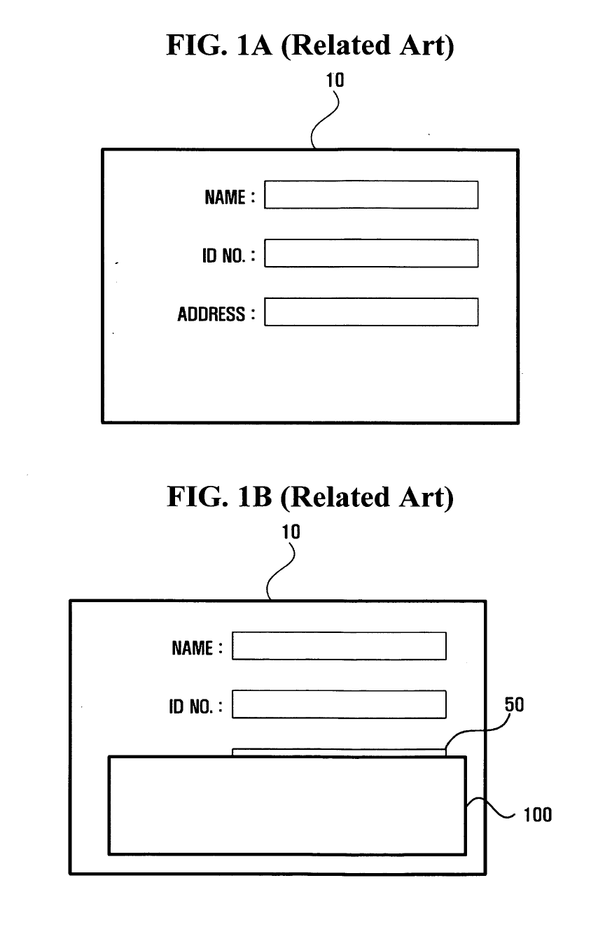

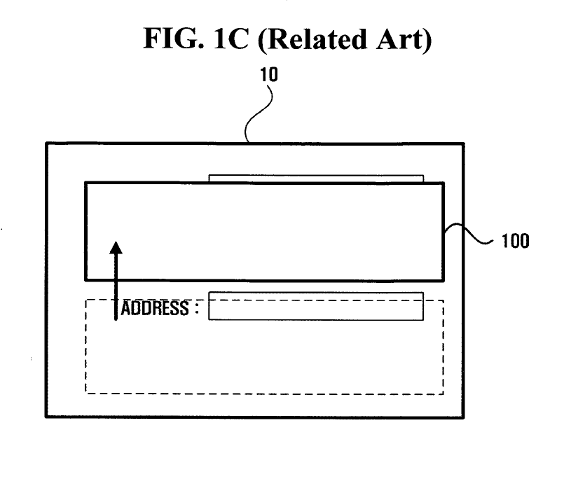

### DETAILED DESCRIPTION OF EXAMPLE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

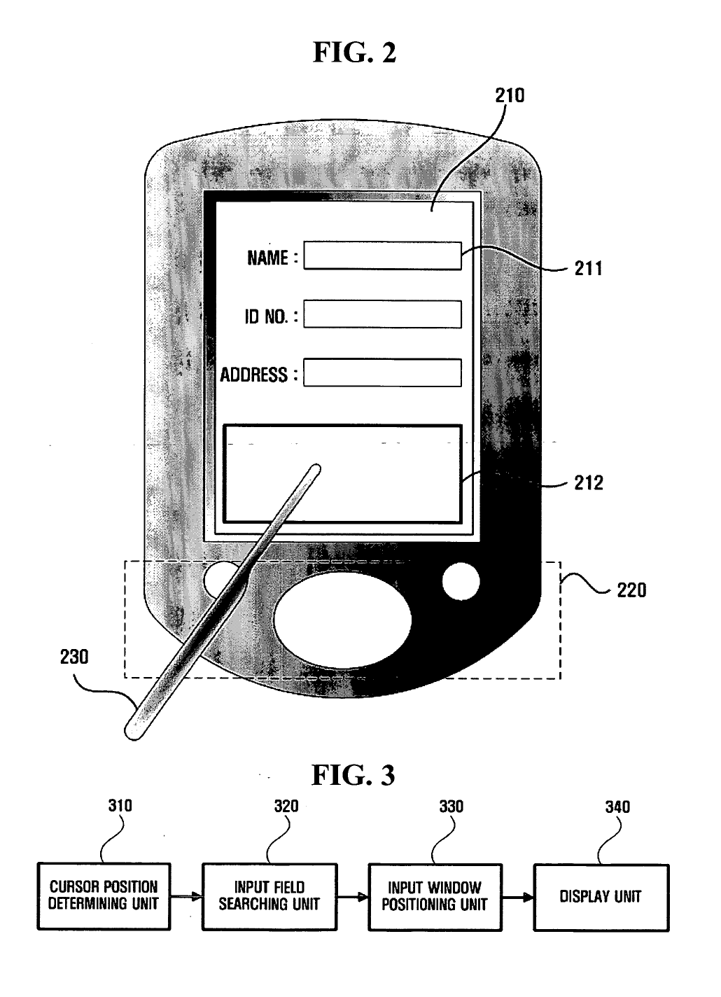

FIG. 2 illustrates an apparatus for displaying an input window according to an embodiment of the present invention. The apparatus comprises a display screen 210, a button unit 220 and a stylus pen 230.

Referring to FIG. 2, the apparatus according to an embodiment of the present invention refers to a mobile device such as a hand-held computer, a personal digital assistant (PDA), or a tablet PC, i.e., a system in which content is input into an input field on a screen without using a keyboard, that is different from a desktop computer or a laptop computer. In order to input desired data into a mobile device, a user uses a stylus pen but does not use a keyboard. For this reason, the apparatus may include an electronically sensitive pad to receive an input from the stylus pen.

The button unit 220 receives a command to move a cursor (not shown) to thereby select a certain input field. Such a command can be input, via a button or a stylus pen, to select the certain input field. At this time, the user may change the position of the cursor using a “move” button or convert the focusing on the certain input field using a “focus conversion” button separately provided on the button unit 220.

The button unit 220 may also include a button to display an input window 212 on the display screen 210. The user selects a certain input field using a “move” button or a “focus conversion” button, and then clicks an “input window display” button, in order to display an input window 212 i on a display screen 210.

The display screen 210 provides a visual display of the selected input field 211 and the input window 212 to receive from the user data (desired content) to be input into the input field 211, via a stylus pen 230. At this time, the displayed input window 212 does not overlay, and therefore, not hide the selected input field 211 or the subject of the input field 211.

As described above, since the apparatus according to the present invention is a mobile device such as a hand-held computer, the user inputs data using the stylus pen 230. Here, an electronically sensitive pad that can receive input from the stylus pen 230 may be provided in the display screen 210 or as a separate device. When the electronically sensitive pad is provided in the display screen 210, the user handwrites a desired content on the displayed input window 212, and then the handwritten content is processed by a predetermined processing unit (not shown) and input into the target input field.

At this time, if the input widow 212 overlays or hides the input field 211 or the subject of the input field 211 as it is displayed on the display screen 210, the user cannot recognize what he/she has currently input. As a result, the user has to remove the input window 212 and then display the target input field 211 again, or has to move the input window 212, in order to ascertain the subject of the target input field 211.

Considering this, the apparatus of the present invention makes it possible that the input window 212 displayed on the display screen 210 does not overlay, or therefore, hide the input field 211 or the subject of the input field 211, a process of which will be described in detail with reference to FIGS. 3 to 10 herein below.

FIG. 3 is a block diagram illustrating an apparatus for displaying an input window according to an embodiment of the present invention, as shown, for example, in FIG. 2. The apparatus comprises a cursor position determining unit 310, an input field searching unit 320, an input window positioning unit 330 and a display unit 340.

The cursor position determining unit 310 identifies the position of a cursor (not shown). When one or more input fields are displayed on the screen of the display unit 340, the user positions the cursor on a certain input field in order to input a desired content. The position of the cursor may be determined by an input means, such as a stylus pen or a pointing device; however, a keyboard can also be incorporated for the user's convenience. In addition, the position of the cursor may also be identified as x and y coordinate values on the screen and the identified position of the cursor is transmitted to the input field searching unit 320.

The input field searching unit 320 searches whether an input field 211, as shown, for example, in FIG. 2, is present on the identified position of the cursor received from the cursor position determining unit 310. When the input field 211 is not present, the input is terminated. When the input field 211 is present, however, the input field searching unit 320 searches for a static text field close to the present input field. The static text field may include information regarding at least one of a position and a size of the static text field.

The static text field indicates information on the basis of which the user can input specific content into a target input field, which may include the subject or additional information on the input field. By checking the static text field close to the input field, the user can determine which content is to be input into the target input field. Accordingly, it is preferable that the static text field is displayed closely to the target input field, possibly in any of the four directions of the static text field. The static text field may include text, and an image such as an icon.

The position of the static text field may be represented based on x and y coordinate values on the screen. For this, the angular point of the leftmost top of the static text field is determined based on the angular point of the left top of the screen.

The size of the static text field is determined by the lengths to the x axis and to the y axis from the angular point indicating the position of the static text field. The size of each static text field may vary according to the implementation method.

The static text field is a type of an object such as an input field. It is possible to determine the position and the size of the static text field, using coordinate values relative to the input field on which the cursor is currently positioned. In other words, the static text field close to the input field focused by the cursor, on the coordinates, is considered as the subject or additional information corresponding to the input field.

The input field searching unit 320 searches for information on the static text field close to the input field on the point where the cursor (not shown) is currently positioned. The cursor may be moved by the stylus pen 230, as shown, for example, in FIG. 2, or a keyboard provided in the apparatus.

The input window positioning unit 330 determines the position of the input window so as not to overlay or hide the static text field, referring to information on the static text field, the margin of the screen and the size of the input window.

When one or more input fields are displayed on a screen of the display unit 240, the basic position of an input window may be the lower part of a display screen 310, as shown, for example, in FIG. 2; however, it is desirable that such an input window is close to the static text field or the input field, in order to allow the user to immediately know the target static text field.

The input window positioning unit 330 positions the input window 212. When the input window is partially or wholly departed from the display screen 210 at a predetermined basic position described above, the position of the input window 212 is determined in such a manner that the input window 212 is wholly displayed on the display screen 210, referring to the information on the static text field, the margin of the screen and the size of the input window 212. For example, in the input field to input the subject and additional information therein, which are the static text fields, the subject may be positioned in the left of the input field and the additional information may be positioned in the lower part of the input field. In this case, the input window 212 is displayed closely to the lower part (basic position) for the additional information, and the left side of the input window 212 is arranged in the static text field for the subject or in the left side of the input field. At this time, when the lower part of the input window 212 is partially or wholly departed from the screen 210, the input window 212 moves to the upper of the input field; when the left side of the input window 212 is partially or wholly departed from the screen 210, the input window 212 moves to the left as much as the predetermined distance.

When a part of the input window 212 is departed from the screen 210 in any sides of the static text field, the size of the input window 212 may be decreased adaptively to the margin of the screen 210.

The display unit 340 displays the input window 212 on the screen 210, as shown, for example, in FIG. 2. The display unit 340 may be a liquid crystal display (LCD) having an electronically sensitive pad that can receive an input from a user using a pointing device such as a stylus pen or a finger.

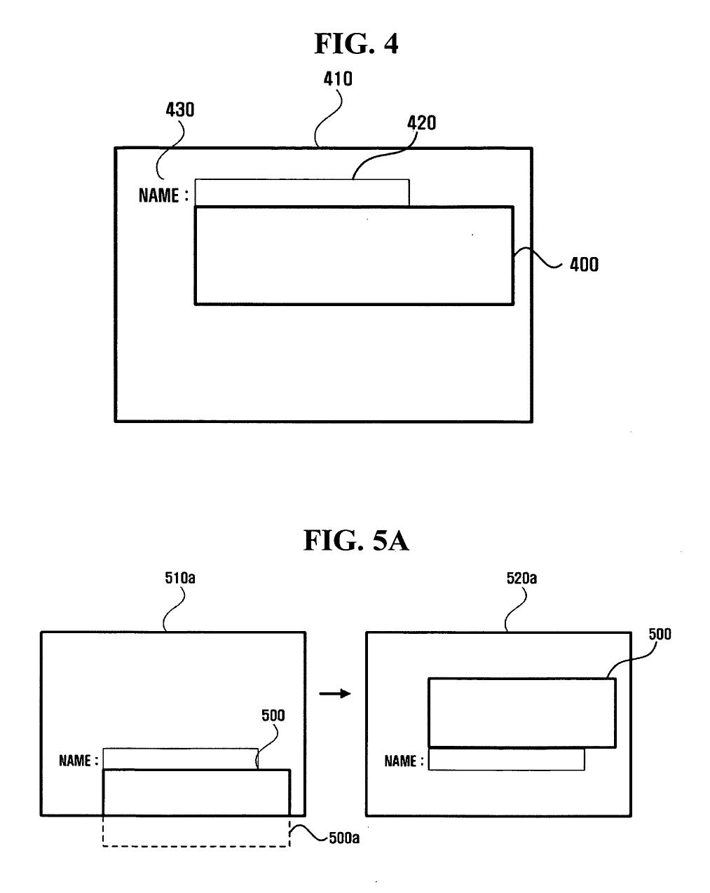

FIG. 4 illustrates an example basic position of an input window 400 depending upon an input field 420 according to an embodiment of the present invention.

The input window 400 is preferably close to the input field 420 so that a user can directly know that the input window 400 is targeted for the input field 420 on a display screen 410. At this time, the input window 400 may be positioned closely to any side of upper, lower, left and right sides of the input field 420 in such a manner that such an input window 400 does not overlay or hide the input field 420 and the static text field 430.

As shown in FIG. 4, the input window 400 is positioned closely to the bottom side of the input field 420 (basic position) and the left end thereof and the left end of the input field 420 are on the same line. However, as described above, the input window 400 may be positioned in any of the top, left and right of the input field 420, and the left end of the static text field 430 and the left end thereof may be on the same line.

In order to position the input window 400 displayed according to a user's command, the input window positioning unit 330 first positions the input window 400 at a predetermined basic position. At this time, if the input window 400 is partially or wholly departed from the display screen 410, the input window positioning unit 330 determines the position of the input window 400 in such a manner that the whole input window 400 is displayed in the next best position.

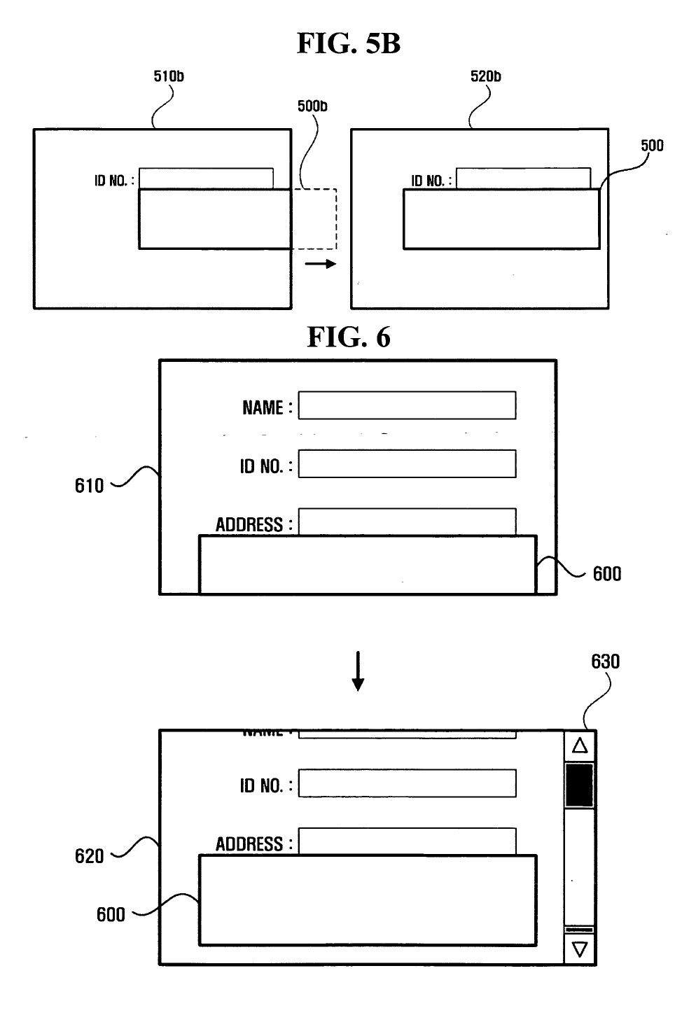

FIGS. 5A and 5B illustrate an example rearrangement of an input window when such an input window is partially or wholly departed from the screen, according to an embodiment of the present invention.

In order to position the input window 500 displayed according to a user's command, the input window positioning unit 330 first positions the input window 500 at a predetermined basic position on a display screen 510A or 510B, as shown in FIG. 5A and FIG. 5B. At this time, if the input window 500 is partially or wholly departed from the screen 510A or 510B, the input window positioning unit 330 positions the input window 500 in the next best position on a display screen 520A or 520B, as shown in FIG. 5A and FIG. 5B, referring to the position and the size of the static text field, the margin of the screen and the size of the input window 500.

The input window 500 may be displayed on the screen as arranged at the end of an input field or the end of the subject thereof. In this case, if a part of the input window 500 is departed from the screen 510B, the input window positioning unit 330 adjusts the position of the input window 500 so that the whole input window 500 is displayed on the screen 520B.

FIG. 6 illustrates an entire input window 600 displayed by scrolling a display screen 610 when the input window 600 is partially or wholly departed from the screen 610, according to an embodiment of the present invention.

When the basic position of the input window 600 is above or below the input field, the position of the input window 600 displayed may be adjusted using a vertical scroll bar 630. In other words, when the input window 600 displayed closely to the concerned static text field is partially or wholly departed from the display screen 610, the whole part of the input window 600 can be displayed by scrolling the display screen 620.

Scrolling may be conducted only to the extent that the whole input display is displayed. According to the basic position of the input window 600, up and down scrolling may be conducted.

Preferably, displaying by the scroll bar 630 of the input window 6100 is applied only when the input window 600 is positioned on or below the static text field. This is because the static text field may be departed from the screen 620 because of horizontal scrolling.

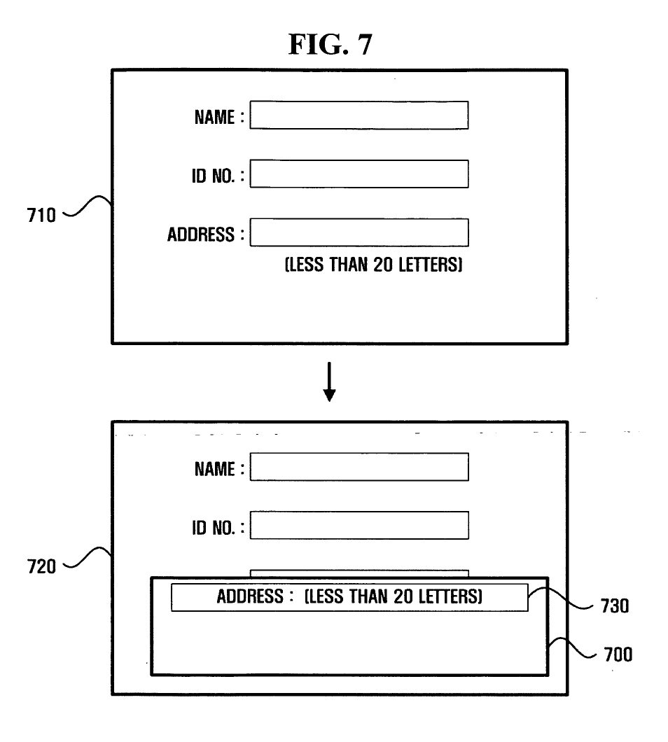

FIG. 7 illustrates an example subject of the target input field displayed on a region of the input window, according to an embodiment of the present invention.

When an input window 700 overlaps an input field A, a problem is created because the user may not ascertain the subject or the additional information of the target input field because they are hidden or overlaid by an input window 700. This problem may be solved by displaying the subject or the additional information of the input field on a predetermined region of the input window 700.

A target input field is focused by a cursor (not shown) before to trigger the input window 700 to be displayed on a display screen 710. The user positions the cursor (not shown) on the target input field using a stylus pen or a pointing device, and the input window positioning unit 330 determines the position of an input window 700 referring to the position and the size of the static text field close to the focused input field. The static text field may include the subject and additional information of the input field. Like the input field, the static input field is a type of an object and the position and the size thereof can be determined using relative coordinate values of the input field.

Referring to the position and information of the static text field present closely to the target input field, the position of the input window 700 is determined, and the text or image included in the static text field is displayed on the predetermined region 730 of the input window 700.

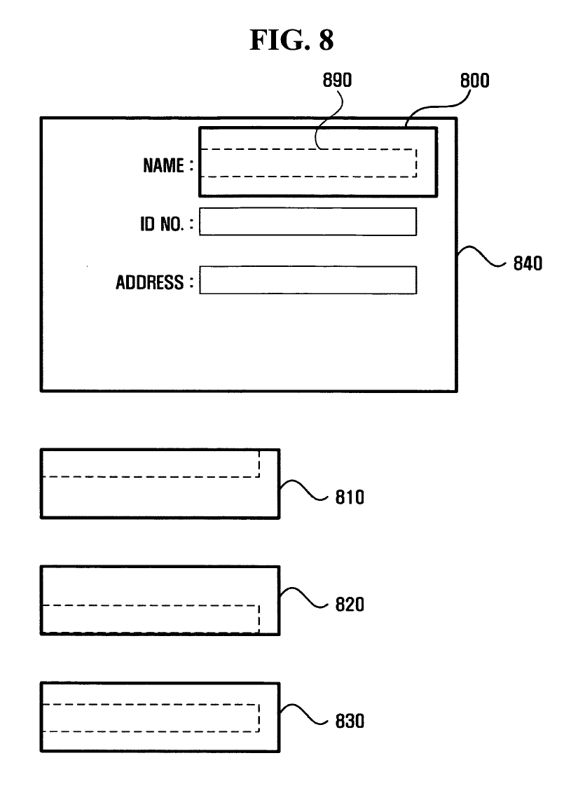

FIG. 8 illustrates an example input window displayed at the position of an input field according to an embodiment of the present invention. As shown in FIG. 8, the positioning of the input window 800 closely to an input field and a static text field makes the user immediately aware that the input window 800 will be used to input content associated with the target input field. Referring to FIG. 8, the input window 800 is displayed at the position of the target input field 890, from which the user inputs a desired content in the input window 800 displayed around the subject of the input field 890, that is, at the position of the input field 890.

The position of the input window 800 may be a point 810 on which the left top angular point of the input window 800 meets the left top angular point of the input field 890, a point 820 on which the left bottom angular point of the input window 800 meets the left bottom angular point of the input field 890, or a point 830 on which the left side of the input window 800 is on the same line with the left side of the input field 890. At this time, when the input window 800 is partially or wholly departed from the screen, the whole input window can be displayed on the screen by moving the input window 800 oppositely to the departed portion, that is, to the inside of the screen 840.

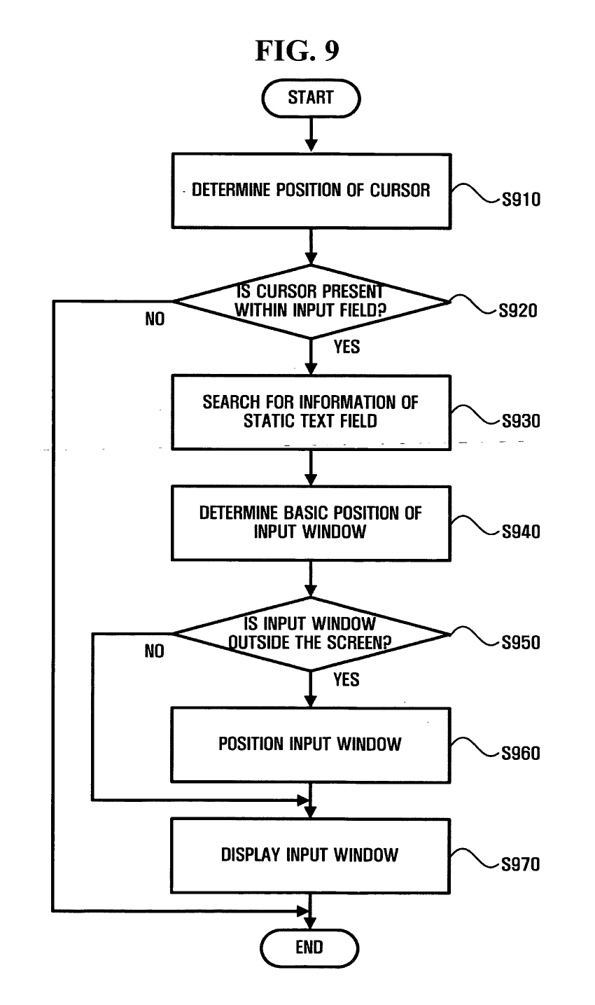

FIG. 9 is a flowchart illustrating an example visual display of an input window in such a manner that an input field is not overlaid or hidden by the input window, according to an embodiment of the present invention.

To input a desired content into a target input field, the user positions a cursor (not shown) at the target input field using a stylus pen or a pointing device, so that the target input field is focused. Accordingly, the cursor position determining unit 310 determines the position of the cursor at operation S910. The position of the cursor can be expressed with x and y coordinates values on a display screen, and the position of the cursor is transmitted to the field searching unit 320.

The field searching unit 320 next determines whether the cursor is present within an input field at operation S920. If the cursor is not present within the input field, the field searching unit 320 stops displaying an input window that does not hide the subject of the input field. If the cursor is present within the input field, the field searching unit 320 searches for information on a static text field at operation S930. Here, the static text field may indicate information regarding at least one of the position and the size of the static text field.

The searched information on the static text field is transmitted to the input window positioning unit 330. The input window positioning unit 330 first determines the basic position of an input window at operation S940. Then, referring to information on the static text field, the margin of the screen and the size of the input window, the input window positioning unit 330 determines whether an input window is departed from the screen, i.e., whether the input window is outside the screen at operation S950. As a result, when the input window is partially or wholly departed from the screen, the input window positioning unit 330 determines the next best position of the input window at operation S960.

As a basic position, the input window may be positioned in any of the four directions of the target static text field so that it cannot hide the static text field indicating the subject or additional information of the input field. In order to allow the user to immediately know that the current input window is to input data into the target input field, the input window is preferably positioned closely to the target input field or the static text field.

The input window is then displayed at the determined position on the display screen, via the display unit 340 at operation S970. Accordingly, the user can input a desired content associated with the target input field on the displayed input window.

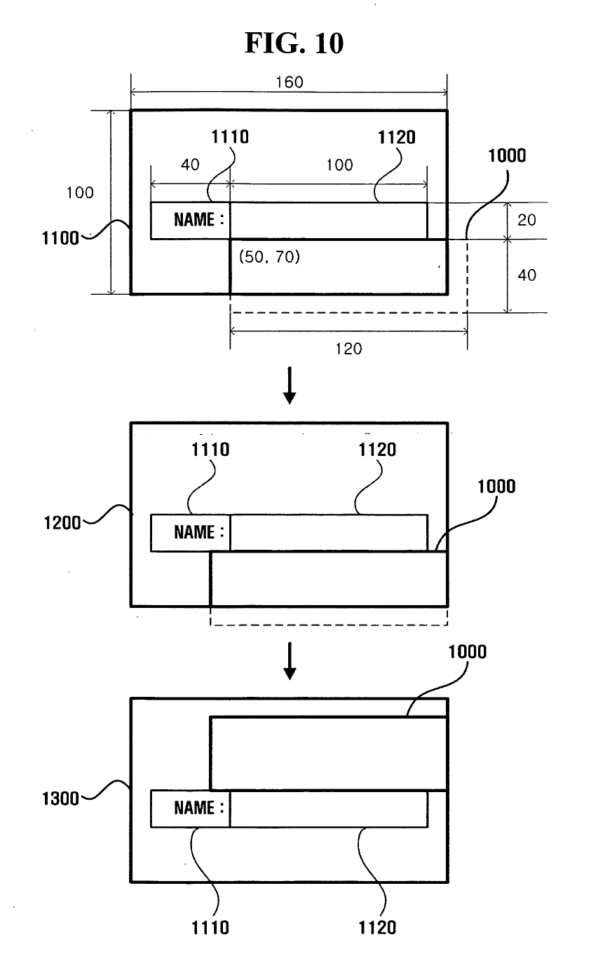

FIG. 10 illustrates an example input window displayed in such a manner that an input field is not overlaid or hidden by the input window according to an embodiment of the present invention. It is assumed that the screen S1100, S1200 and S1300, fields 1110 and 1120 and the size of the input window 1000 are the same as those illustrated in FIG. 10.

When the user inputs a command to provide a visual display of an input window after having positioned a cursor at an input field 1120 on a display screen 1100, using a stylus pen or a keyboard, the input window positioning unit 330 determines the basic position of the input window 1000 on a display screen 1100. In FIG. 10, it is also assumed that as the basic position, the input window 1000 is on the same line with the left side of the input field 1120. At this time, it should be noted that the input window 1000 is not displayed on the screen 1100, but this position is determined as the initial position of the input window 1000.

After the basic position of an input window 100 has been determined, the input window positioning unit 330 determines whether the input window 1000 is departed from the screen 1100, referring to the size of the screen, the position and the size of the input window 1000. In other words, when the size of the screen 1100 is 160×100, and that of the input window is 120×40, the left top angular point of the input window 1000 should be positioned within the coordinate values of 40×60 in the horizontal axis and the vertical axis respectively. However, since the basic position of the input window 1000 is (50, 70), the input window 100 is departed from the screen S100 by 10 both in the horizontal axis and the vertical axis.

According to modified position to the horizontal axis, the input window positioning unit 330 moves the input window 1000 by 10 to the left on a display screen 1200, and then in an upward direction, considering the size of the vertical axis of the input field or static text field.

In determining the position of the input window 1000 departed from the screen 1100, the input window positioning unit 330 may apply a predetermined algorithm. The position of the input window 1000 is determined, considering the positions of the screen and of each input field. Accordingly, to make the entire input window 1000 displayed on the screen, the left top angular point of the input window 1000 should be positioned within the range of (0,0) to (40, 60) as described above. The position that the input window 1000 does not overlay or hide the static text field 1110 within the range of (0,0) to (40, 60) is within the range of (0,0) to (40,10). The position that the input window 1000 does not overlay or hide the input field 1120 within the range of (0,0) to (40, 10) is within the range of (0,0) to (40,10).

Accordingly, the position of the left top angular point of the input window 1000 that does not hide each input field when it is entirely displayed on the screen becomes (0,0) to (40,10).

As described above, an apparatus and a method for displaying an input window according to the present invention may have one or more advantages as described below. First, the user can immediately know the content of the input field currently handwritten by the user, by allowing an input window to receive handwriting by the user using a stylus pen, and not to hide the input field or the subject of the input field. Second, the user can directly know the target input field currently input, by positioning the input window closely to the input field using automatic scrolling and automatic modification of the size of the input window.

Various aspects and example embodiments of the present invention can be written as computer programs and can be implemented in general-use digital computers that execute the programs using a computer readable recording medium. Examples of the computer readable recording medium include magnetic storage media (e.g., ROM, RAM, floppy disks, hard disks, etc.), optical recording media (e.g., CD-ROMs, DVDs, etc.), and storage media such as carrier waves (e.g., transmission through the Internet). The computer readable recording medium can also be distributed over network coupled computer systems so that the computer readable code is stored and executed in a distributed fashion. Functional programs, codes and code segments for embodying the present invention may be easily deducted by programmers in the relevant art.

In addition, the method for providing a visual display of an input window, as shown in FIG. 9, and the components of an apparatus, as shown in FIG. 3, can be implemented as a library, or an application framework. Such a method can be a software module written in different computer programming languages, including, but not limited to C, C++, C#, Java and Delphi, and can be integrated in either an operating system (OS) or a user interface, or alternatively, resides as a separate layer on top of the operating system (OS) or the user interface.

While there have been illustrated and described what are considered to be example embodiments of the present invention, it will be understood by those skilled in the art that various changes in form and modification may be made therein, and equivalents may be substituted for elements thereof without departing from the spirit and scope of the present invention. For example, an operating system (OS) for a mobile device used to support a user interface includes, but not limited to, Apple Mac OS, Microsoft Windows (Windows 95, Windows XP or Windows 2000) and the X Window system. Similarly, a central controller can be implemented as a chipset, or alternatively, a general or special purposed computer programmed to perform the methods as described with reference to FIG. 9. In addition, the cursor position determining unit, the field searching unit and the input window positioning unit can be implemented by a single controller configured to perform all functions related thereto. Accordingly, it is intended, therefore, that that present invention not be limited to the various example embodiments disclosed, but that the present invention includes all embodiments falling within the scope of the appended claims.

What is claimed is:

1. An apparatus for displaying an input window to receive handwriting by a user, to be input into one or more input fields, the apparatus comprising:
a cursor position determining unit to determine the position of a cursor;
a field searching unit to search for information regarding an input field when the cursor is present within an input field;
an input window positioning unit to determine the position of the input window in such a manner that the input field or a static text field close to the input field is not overlaid or hidden, referring to information on the searched input field, the margin of a screen and the size of the input window; and
a display unit to provide a visual display the input window at the determined position.

2. The apparatus of claim 1, wherein information regarding the input field includes at least one of the position and size of the input field and those of a static text field close to the input field.

3. The apparatus of claim 1, wherein the input window positioning unit determines the position of the input window in such a manner that the input window is positioned closely to the input field or the static text field.

4. The apparatus of claim 3, wherein the input window positioning unit determines the position of the input window so that the input window is wholly displayed in the margin of a screen of the display unit, when the input window close to the input field or the static text field is partially or wholly departed from the screen.

5. The apparatus of claim 3, wherein the input window positioning unit determines the position of the input field as the position of the input window.

6. The apparatus of claim 1, further comprising a scroll unit to scroll the screen when the input window is partially or entirely departed from a screen of the display unit, to thereby allow the input window to be entirely displayed on the screen.

7. The apparatus of claim 1, wherein the input window includes text or image of the static text field close to the input field.

8. An apparatus for displaying an input window to receive handwriting by a user, to be input into one or more input fields, the apparatus comprising:
a button unit arranged to receive a command to move a cursor to thereby select a certain input field; and
a display unit arranged to display the input window so as not to hide the input field selected according to the received move command.

9. The apparatus of claim 8, wherein the input window is a predetermined space of the display unit to receive and display handwriting by the user, associated with the selected input field.

10. The apparatus of claim 9, wherein the display unit has an electronically sensitive pad to receive the handwriting by the user through the predetermined space on which the input window is positioned.

11. A method for displaying an input window to receive handwriting by a user, to be input into one or more input fields, the method comprising:
determining the position of a cursor;
searching for information on an input field when the cursor is present within the input field;
determining the position of the input window in such a manner that the input field or a static text field close to the input field is not overlaid or hidden by the input window, referring to information on the searched input field, the margin of a screen and the size of the input window; and
(d) displaying the input window at the determined position on the screen.

12. The method of claim 11, wherein information on the input field includes at least one of the position and size of the input field and those of a static text field close to the input field.

13. The method of claim 11, wherein the position of the input window is determined in such a manner that the input window is positioned closely to the input field or the static text field.

14. The method of claim 13, wherein the position of the input window is determined so that the input window is entirely displayed in the margin of the screen, when the input window close to the input field or the static text field is partially or wholly departed from the screen.

15. The method of claim 13, wherein the position of the input field is determined as the position of the input window.

16. The method of claim 11, further comprising scrolling the screen when the input window is partially or entirely departed from the screen, to thereby allow the input window to be entirely displayed on the screen.

17. The method of claim 11, wherein the input window includes text or image of the static text field close to the input field.

18. A method for displaying an input window to receive handwriting by a user, to be input into one or more input fields, the method comprising:
receiving a command to move a cursor to thereby select a certain input field; and
displaying the input window in such a manner the input field selected according to the received Move command is not hid.

19. The method of claim 18, wherein the input window is a predetermined space of the display unit to receive and display handwriting by the user, associated with the selected input field.

20. The method of claim 19, wherein the handwriting by the user is received through the predetermined space on which the input window is positioned.

21. A computer readable medium comprising instructions that, when executed by a mobile device for providing a visual display of an input window to receive handwriting to be input from a user into one or more input fields on a display screen, perform the method comprising:
determining the position of a cursor;
searching for information regarding an input field when the cursor is present within an input field;
determining the position of the input window in such a manner that the input field or a static text field close to the input field is not overlaid or hidden, referring to information on the searched input field, the margin of the display screen and the size of the input window; and
providing a visual display the input window at the determined position.

22. The computer readable medium of claim 21, wherein information regarding the input field includes at least one of the position and size of the input field and those of a static text field close to the input field.

23. The computer readable medium of claim 21, wherein the position of the input window is determined in such a manner that the input window is positioned closely to the input field or the static text field.

24. The computer readable medium of claim 23, wherein the position of the input window is determined so that the input window is wholly displayed in the margin of the display screen, when the input window close to the input field or the static text field is partially or wholly departed from the display screen.

25. The computer readable medium of claim 21, further comprising scrolling the display screen when the input window is partially or entirely departed from the display screen, to thereby allow the input window to be entirely displayed on the display screen.
